(19) United States
(12) Patent Application Publication
(10) Pub. No.: US 2004/0205724 A1
(43) Pub. Date: Oct. 14, 2004

(54) Software test message streams

(76) Inventor: Thomas Mayberry, Holliston, MA (US)

Correspondence Address: David W. Rouille, Daly, Crowley & Mofford, LLP, Suite 101, 275 Turnpike Street, Canton, MA, 02021, US

(21) Appl. No.: 10/099,833

(22) Filed: Mar. 14, 2002

Related U.S. Application Data
(60) Provisional application No. 60/277,078, filed on Mar. 19, 2001.

(51) Int. Cl. G06F 9/44

(52) U.S. Cl. 717/124

(57) ABSTRACT

The present invention allows the user of the tool to easily and quickly determine where various types of data are to be sent during the operation of the tool. A particular type of data may be sent to one or more of a variety of devices including various text windows, the status bar, a popup message box, to one or more files, or the user may choose to ignore a particular type of data altogether. The presently disclosed method is accomplished by a software interface which permits two things to happen. First, all data targeted at the user is assigned by the user to a particular stream as opposed to being sent to a specific device. Second, the tool provides a user interface control that allows the user to determine which devices (if any) are to be connected to which streams.

### CROSS-REFERENCE TO RELATED APPLICATIONS

This application claims priority under 35 U.S.C. § 119(e) from U.S. provisional application No. 60/277,078 filed on Mar. 19, 2001, the disclosure of which is hereby incorporated by reference.

### FIELD OF THE INVENTION

The present invention relates generally to a manner of handling messages while performing a test and more specifically to a method allowing a user to assign particular data messages to particular devices through the use of message streams.

### BACKGROUND OF THE INVENTION

All testing tools generate data that the user needs access to at various points during the use of the tool. This data includes such things as error or informational messages as well as the text that makes up a particular report. It may also include testing results such as the amount of time required to execute each method of the component under test. There are two main problems with these known test tools.

A first problem associated with these known test tools is that often times the different types of data provided by the tool are intermixed. For example, error, warning, and informational messages are often sent to the same place (such as a message window). It is easy to miss an important error message because it gets lost among all of the informational messages.

A second problem associated with these known test tools is that a particular set of data is always directed to the same place. For example, error messages may only go to an error message window when in fact the user may want to send them to a file so that they can later be analyzed. Extending this example, the warning messages that are normally mixed in with the error messages may want to end up in another file or may not be of interest at all.

One approach that has been used to help solve this problem includes the use of on/off or brief/verbose switches. For example, a switch is provided to ignore informational messages and not send them to their designated device. This is very limiting in that it simply allows the user to ignore a particular type of message if that is what is desired. The verbose/brief switch is even more limiting, in that the switch simply permits the tool to either provide all of the data or some abbreviated set chosen by itself (as opposed to be chosen by the user).

It would, therefore, be desirable to provide a method of assigning the various types of data provided by the test tool to user selected devices. It would further be desirable to provide such a method which is easy to use and inexpensive to implement.

### SUMMARY OF THE INVENTION

The present invention allows the user of the tool to easily and quickly determine where various types of data are to be sent during the operation of the tool. A particular type of data may be sent to one or more of a variety of devices including various text windows, a status bar, a popup message box, to one or more files, or the user may choose to ignore a particular type of data altogether. The presently disclosed method is accomplished by a software interface which permits two things to happen. First, all data targeted at the user is assigned by the user to a particular stream as opposed to being sent to a specific device. Second, the tool provides a user interface control that allows the user to determine which devices (if any) are to be connected to which streams.

### BRIEF DESCRIPTION OF THE DRAWINGS

The invention will be more fully understood from the following detailed description taken in conjunction with the accompanying drawings, in which:

FIG. 1 is a flow chart of the presently disclosed method; and

FIG. 2 is a screen shot showing the user interface used to accomplish the present invention.

### DETAILED DESCRIPTION OF THE INVENTION

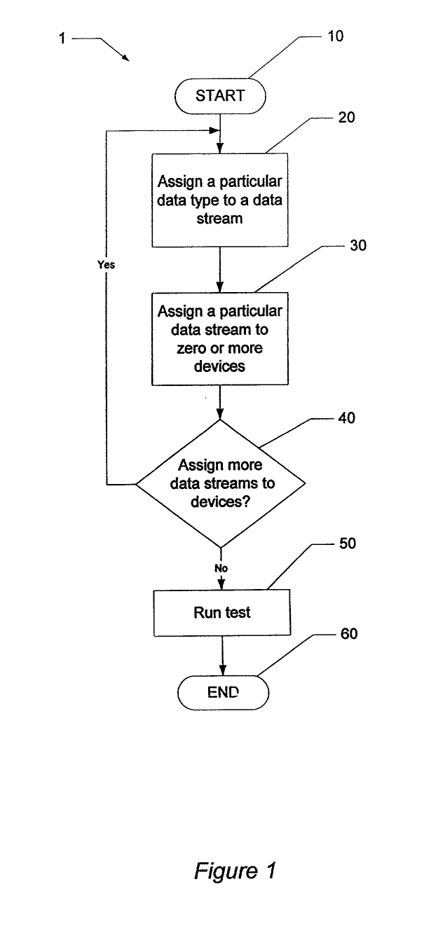

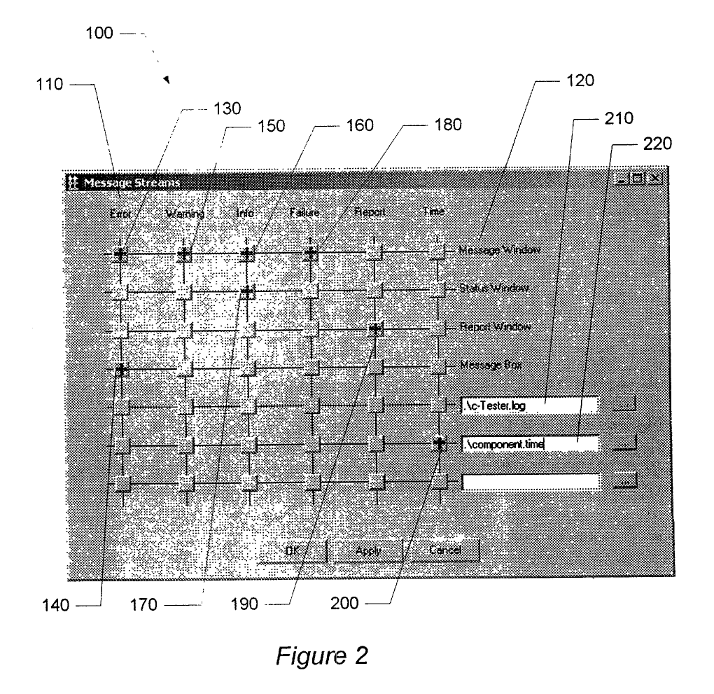

Referring now to FIGS. 1 and 2, the present invention is disclosed. The present invention allows a user of a software program to easily and quickly determine where various types of data are to be sent during the operation of the tool. A particular type of data may be sent to one or more of a variety of devices including various text windows, a status bar, a popup message box, or to one or more files. Optionally, the user may choose to ignore a particular type of data altogether. The tool accomplishes this by doing two things. First, all data targeted at the user is “placed” onto a particular stream as opposed to being sent to a specific device. For example, all error messages are placed onto the error stream as opposed to being sent to the message window. Second, the tool provides a user interface control that allows the user to determine which devices (if any) are to be connected to which streams. For example, the error stream could be connected to the status bar and to a file of the user's choice. This would cause all error messages to be displayed in the status bar and to be written to the specified file as well.

A flow chart of the presently disclosed method is depicted in FIG. 1. The rectangular elements, are herein denoted “processing blocks” and represent computer software instructions or groups of instructions. The diamond shaped elements, are herein denoted “decision blocks,” represent computer software instructions, or groups of instructions which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required to operate a distributed Raman amplifier in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

The method 1 is started in step 10. This starting step may include performing such functions as loading the desired software or tool, initializing the system, determining which data types are available from the software, or the like.

Step 20 is performed next. At step 20 a particular data type is assigned to a particular Data steam. The software performs this step. For example, error messages will be assigned to an error stream. In certain situations it may be desirable to not assign a particular data stream to any device.

The next step, step 30, assigns a particular data stream to one or more devices. This will be described in detail below. Once a data stream has been assigned to one or more devices, the step is completed.

At step 40 a determination is made as to whether there are more data streams which need to be assigned. If it is desired to assign more data stream s then step 30 is repeated. When the user has assigned all the data streams he or she wishes to assign to devices, step 40 is complete.

Following the completion of step 40, step 50 is executed. At step 50 the tool is run, with any resulting messages being delivered to the assigned device(s). Upon completion of step 50, the method is finished, as shown in step 60.

Referring now to FIG. 2, the user interface control 100 for connecting streams to devices is shown. The streams 110 are shown extending along the top of the matrix. The devices 120 that the streams can be connected to are shown along the right side of the matrix. In this particular example the streams comprise an Error Stream, a Warning Stream, an Info stream, a Failure Stream, a Report stream and a Time stream. The devices to which the various streams may be directed include a Message Window, a Status Window, a Report window, a Message Box, and specific user-defined files.

Clicking the buttons at the points of intersection of a stream and a device will either connect or disconnect that stream to that device. As shown in FIG. 2, the stream labeled Error is directed to the Message Window since box 130 has been set. Further, box 140 has been set such that all Error messages will also be provided to the Message Box. None of the other boxes associated with the Error message stream have been set, therefore any error messages will only be provided to the Message Window and Message Box.

All Warning messages, as indicated by box 150, will be sent to the Message Window. Since no other boxes associated with the Warning message stream are set, Warning messages will only be provided to the Message Window and no where else.

Info messages will be directed to two devices as indicated by boxes 160 and 170 being set. Accordingly, all Info messages will appear in the Message Window and also in a Status window.

Failure messages will be directed to the Message Window as shown by box 180 being set. Since no other boxes have been set which correlate to the Failure message stream, the Message Window is the only device which will receive Failure messages.

Report messages will be directed to a Report Window as indicated by box 190. Report messages will not be delivered to any other devices.

Time messages will be written to file labeled “component.time” as indicated by box 200 being checked. Time messages will not be recorded elsewhere.

A file labeled “tester.log” will not receive any messages, as no boxes corresponding to this device have been set.

As shown in FIG. 2, the Message Window will receive Error messages, Warning Messages, Info messages, and Failure messages. The Report Window will receive Report messages. The file “Tester.log” will not receive any messages. The file “component.time” will receive Time messages.

As described above, the interface 100 provides a simple and effective way to direct message streams to specific devices. The arrangement can be easily modified and applied by a few simple mouse clicks.

While specific message types and devices were described, it should be appreciated that the presently disclosed method could be used with any type of message and any type of device.

This approach could just as easily be applied to any other tool. The streams facility is completely configurable allowing the particular streams and devices required by a particular application to be set by that application without requiring any modifications to the facility itself.

Having described preferred embodiments of the invention it will now become apparent to those of ordinary skill in the art that other embodiments incorporating these concepts may be used. Additionally, the software included as part of the invention may be embodied in a computer program product that includes a computer useable medium.

For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims. All publications and references cited herein are expressly incorporated herein by reference in their entirety.

What is claimed is:

1. A method of directing message streams comprising:
assigning at least one of a plurality of data types to at least one of a plurality of data streams; and
assigning said at least one of a plurality of data streams to at least one of a plurality of devices.

2. The method of claim 1 wherein said plurality of data types are selected from error data, warning data, failure data, report data, and time data.

3. The method of claim 1 wherein said plurality of data streams are selected from an error stream, a warning stream, a failure stream, a report stream and a time stream.

4. The method of claim 1 wherein said plurality of devices are selected from a message window, a status window, a report window, a message box, and a file.

5. The method of claim 1 wherein said assigning at least one of a plurality data types is done though a software interface presented to a user.

6. The method of claim 1 wherein said assigning at least one of a plurality data streams is done though a software interface presented to a user.

7. A computer program product comprising a computer usable medium having computer readable code thereon, including program code comprising:
instructions for assigning at least one of a plurality of data types to at least one of a plurality of data streams; and
instructions for assigning said at least one of a plurality of data streams to at least one of a plurality of devices.

8. The computer program product of claim 7 wherein said plurality of data types are selected from error data, warning data, failure data, report data, and time data.

9. The computer program product of claim 7 wherein said plurality of data streams are selected from an error stream, a warning stream, a failure stream, a report stream and a time stream.

10. The computer program product of claim 7 wherein said plurality of devices are selected from a message window, a status window, a report window, a message box, and a file.

11. The computer program product of claim 7 wherein said assigning at least one of a plurality data types is done though a software interface presented to a user.

12. The computer program product of claim 7 wherein said assigning at least one of a plurality data streams is done though a software interface presented to a user.
